(19) United States
(12) Patent Application Publication
(10) Pub. No.: US 2008/0003391 A1
(43) Pub. Date: Jan. 3, 2008

(54) Expanded content label for bi-directional application

(76) Inventors: Joseph D. Franko, Ham Lake, MN (US); Joseph D. Franko, Dayton, MN (US); Bruce J. Schurmann, Bloomington, MN (US)

Correspondence Address: WALTER K. ROLOFF, 490 HARBOR COURT, SHOREVIEW, MN, 55126, US

(21) Appl. No.: 11/477,059

(22) Filed: Jun. 28, 2006

(51) Int. Cl. B32B 33/00

(52) U.S. Cl. 428/40.1; 428/43

(57) ABSTRACT

In a first embodiment, an expanded content label for bi-directional application includes at least one top ply, at least one bottom ply, selected graphics, a first leading edge, a second leading edge, and a first release-reseal system and a second release-reseal system, each being associated with, respectively, the first leading edge and the second leading edge. In a second embodiment, the label includes at least one top ply, at least one bottom ply, selected graphics, a first leading edge, and an opposite leading edge, wherein the first leading edge includes a hinge portion and the opposite leading edge includes (i) a cut through the at least one top ply, (ii) a set-back portion defined by the cut and the opposite leading edge, and (iii) a release-reseal system adjacent to the cut and the set-back portion.

### FIELD OF THE INVENTION

The present invention relates generally to labels. The invention relates specifically to an expanded content label for bi-directional application, regardless of processing directions of label application equipment or filling lines.

### BACKGROUND OF THE INVENTION

In the printing arts, and in particular in the commercial printed label art for labeling and decorating consumer products, there exists a continual demand for labels and decorations which not only appeal to consumers, but also bear ever increasing amounts of printed information. For example, labels for identification of consumer health care and pharmaceutical products are often required by governmental regulations to describe in painstaking detail their compositions and ingredients. As new food and drug laws are passed, regulations require the inclusion of increasing amounts of label information. Manufacturers of consumer products and their packaging vendors have devised various schemes for inclusion of such extensive information. Among these are simply printing the information in small type on product container boxes or cartons, or including information insert sheets within the boxes or cartons. Obvious drawbacks to these schemes include increased packaging costs associated with boxes and cartons, and the fact that boxes, cartons, and insert sheets are often promptly discarded by a consumer and therefore do not remain with their respective products during their lifetimes.

In general in the labeling and packaging arts, various forms of so-called “extended text” and “expanded content”labels (collectively, “expanded content labels” or “ECLs”) have been proposed to provide increased printed information. One such expanded content label type that has gained wide popularity is the booklet type label, where a base ply is joined to a top ply via an adhesive coupling or “hinge” between the two plies, and an open/close portion or “release-reseal system” between the two plies is provided at an opposite end of the label. An early example of this type of label is disclosed in U.S. Pat. No. 5,264,265 issued to Kaufmann, entitled “PEEL-BACK RE-SEALABLE MULTI-PLY LABEL”.

Commonly, in high-speed labeling environments such as exists with label application equipment and filling lines, expanded content labels are dispensed in rapid, successive fashion whereby they are affixed, respectively, to containers moving in a “left hand first” or “right hand first” direction or rotation with respect to application equipment and filling line orientation as is well known. The left hand first or right hand first directions or rotations require that an ECL be operative for that direction as will be further described; but for a simple single-ply label (one that is printed only on its front face) only graphic and aesthetic sensitivities would be of concern. As known to those of skill in the label application arts, a hinge of an expanded content label for an overlapping, wrap-around label (with an application circumference of greater than 360 degrees) is preferably first affixed at its leading edge, at point of application, to a container, followed by affixing the release-reseal system end of the label at its trailing edge so that the release-reseal system is not covered over by the opposite edge where the hinge is located. In other words, the hinge may be covered over by an overlapping label portion (effectively, a circumferential wrap about the container of greater than 360 deg.) but the release-reseal system must not be so overlapped for it to function properly.

This directional constraint on overlapping, wrap-around (greater than 360 deg.) ECLs exists in so-called “roll fed”, “pressure-sensitive”, “cut and stack”, “hot melt”, and “glue-applied” applications. As mentioned above, those of ordinary skill in the label application arts will recognize that such directional constraints really do not exist with regard to simple single-ply labels; for the most part, it is not critical which end of a simple single-ply label overlaps the other upon application of the label to a container since, notwithstanding graphic and aesthetic concerns, simple single-ply labels are not expected to function like, or be manipulable as, ECLs.

To address the directional requirement it has been typical for providers of labels to manufacture them, and identify them as being, for use in a particular direction or rotation according to the customers' needs.

Of course, requiring labels to be manufactured according to application direction or rotation leads to a need for increased label inventories, higher costs, and diminished efficiencies in running label application equipment and filling lines for customers. Furthermore, in multiple plant locations and in multiple filling lines within a customer's plant, multiple similar and dissimilar label directions are typically required. Such multitudinous label inventory requirements result in increased customer inefficiencies and costs. Therefore, it would be decidedly advantageous to provide an ability to “run,” a specific ECL in either a right hand first or left hand first direction (i.e., bi-directionally) and thereby avoid the inefficient and costly requirement of maintaining inventories of opposite direction labels. In other words, it would be of tremendous benefit for a customer to be able to run a given label on either a left hand first or a right hand first line. This advantage would extend to the label manufacturer as well, since only one set of artwork would be needed to supply a customer with labels, regardless of the customer's line direction. Further, only one “part number” would be required to identify such a label, in contrast to conventional ECLs where a separate, discrete part number is needed to identify the labels of each opposing direction.

### SUMMARY OF THE INVENTION

An object of the present invention is to provide an expanded content label for bi-directional application that is inexpensive and simple to produce.

Another object of the present invention is to provide an expanded content label for bi-directional application that may be readily utilized in either left hand first or right hand first application environments.

In accordance with the present invention, in a first embodiment, an expanded content label for bi-directional application includes at least one top ply, at least one bottom ply, selected graphics, a first leading edge, a second leading edge, and a first release-reseal system and a second release-reseal system, each being associated with, respectively, the first leading edge and the second leading edge. In a second embodiment, the label includes at least one top ply, at least one bottom ply, selected graphics, a first leading edge, and an opposite leading edge, wherein the first leading edge includes a hinge portion and the opposite leading edge includes (i) a cut through the at least one top ply, (ii) a set-back portion defined by the cut and the opposite leading edge, and (iii) a release-reseal system adjacent to the cut and the set-back portion.

### BRIEF DESCRIPTION OF THE DRAWINGS

FIG. 1 is a schematic illustration of a conventional expanded content label of a particular construction being affixed to a container in a process that is moving in a compatible direction.

FIG. 1a is an illustration of the conventional expanded content label of FIG. 1, after having been affixed to the container by the process of FIG. 1.

FIG. 1b is a schematic illustration of the conventional expanded content label of FIG. 1, being affixed to a container in a process that is moving in an un-compatible direction.

FIG. 1c is an illustration of the conventional expanded content label of FIG. 1, after having been affixed to the container by the process of FIG. 1b.

FIG. 2 is a schematic illustration of an expanded content label for bi-directional application of the present invention, being affixed to a container in a process that is moving in a selected direction.

FIG. 2a is an illustration of the expanded content label for bi-directional application of FIG. 2, after having been affixed to the container by the process of FIG. 2 in the D direction.

FIG. 3 is a schematic illustration of an alternative embodiment of the label of the present invention, being affixed to a container in a process that is moving in a selected direction.

FIG. 3a is an illustration of the label of FIG. 3, after having been affixed to the container by the process of FIG. 3 in the D direction.

FIG. 3b is an illustration of the label of FIG. 3, after having been affixed to the container by the process of FIG. 3 in the D′ direction.

### DETAILED DESCRIPTION OF THE INVENTION

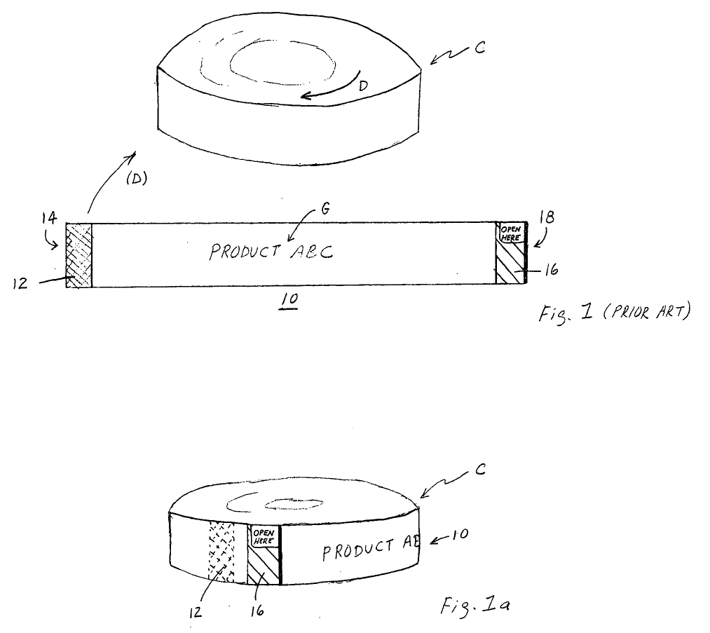

Referring to FIG. 1, there shown is a conventional prior art expanded content label 10 of a particular construction, being affixed to a container C in a process that is moving in a compatible direction as will be further described. Label 10, as is well known, is constructed from a top ply of material and a bottom ply of material (which may be identical materials). The plies together define a hinge 12 at leading edge 14, and a release-reseal system 16 at an opposite trailing edge 18. Label 10 may, of course, have any desired graphics G on any surfaces of the top and bottom plies. It is to be understood that as used herein throughout, and in the drawings, the term “graphics” includes, but is not limited to: various printing media; adhesives; hot melts; varnishes; inks; release coatings; hot and cold foil stampings; and any suitable additions to, or deletions from, a label ply.

In FIG. 1a, conventional ECL 10 is shown has having been fully affixed to container C by the process of FIG. 1, moving in compatible direction D. In this typical prior art example, it is to be noted that label dimensions have been chosen such that label 10 may be wrapped around container C slightly in excess of, circumferentially, 360 degrees. Thus, in this prior art example, trailing edge 18 overlaps leading edge 14, with hinge 12 being consequently covered over by that portion of label 10 adjacent to release-reseal system 16 and trailing edge 18. It will be appreciated that this prior art ECL, having been affixed to container C in a process that was moving in compatible direction D, may be opened and closed in booklet fashion, since release-reseal system 16 is unobstructed and regardless of whether hinge 12 is covered over as aforedescribed.

In FIG. 1b, the exemplary prior art ECL of FIG. 1 is shown as being affixed to container C in a process that is moving in an un-compatible direction D′. It will be recognized that in direction D′, trailing edge 18 must first be affixed to container C, rather than leading edge 14 first under the successful, compatible process of FIGS. 1-1a. Consequently, as shown in FIG. 1c, the requirement of FIG. 1b that trailing edge 18 be affixed first to container C results in an inoperative booklet feature. With particular reference to FIG. 1c, it is apparent that a process utilizing un-compatible direction D′ results in trailing edge 18 of ECL 10 being covered over by a portion of the label adjacent to leading edge 14 and hinge 12, thereby rendering release-reseal system 16 inoperative and not visible to a consumer. Consequently, the consumer would not even recognize that labeling on container C includes additional information or graphics through the booklet feature of ECL 10; thus important information regarding, for example, governmental warnings, instructions for use and safety, and potentially allergic ingredients, could go dangerously unnoticed.

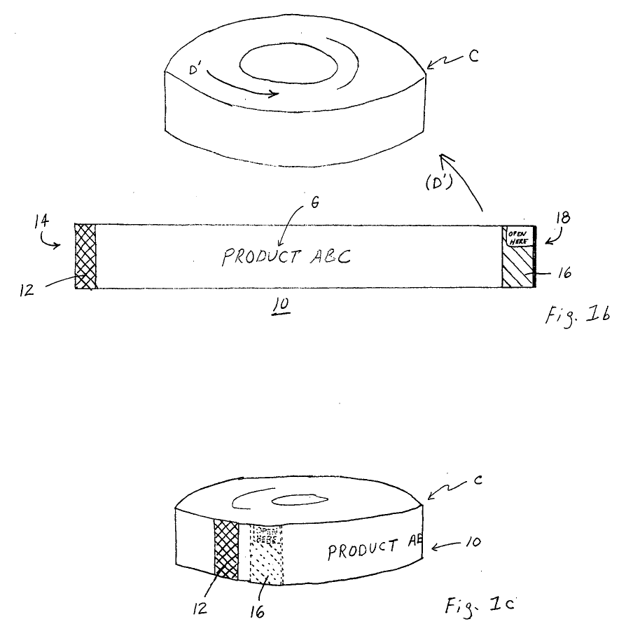

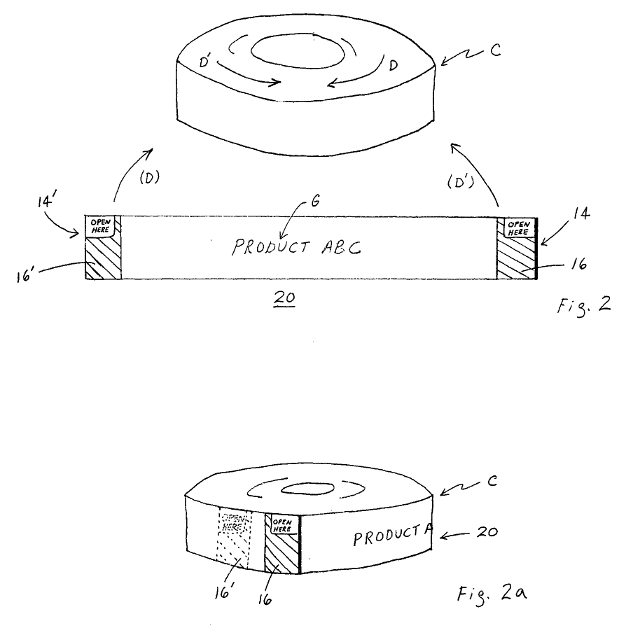

Turning, now, to FIG. 2, there shown is a schematic illustration of an expanded content label for bi-directional application 20 of the present invention which overcomes the myriad aforementioned difficulties. In particular, expanded content label for bi-directional application 20 of the present invention is shown as being capable of being successfully affixed to and operative with a container in a process that is moving in either direction D or D′. Label 20, like prior art label 10, includes top and bottom material plies, and may include additional interior plies. Like label 10, novel label 20 may have any desired graphics G on any surfaces of the plies. Also like label 10, label 20 if desired may be carried on a silicone liner in web fashion, wherein a pressure-sensitive adhesive is provided on the back side of the bottom ply, with the bottom ply being, in turn, in contact with and carried upon the underlying silicone liner (not illustrated) as is well known. However, unlike label 10, label 20 incorporates two opposing leading edges 14 and 14′, each having, respectively, release-reseal systems 16 and 16′ therein in a novel and heretofore unknown construction which overcomes the aforedescribed problems associated with un-compatible application process directions. Thus, it will be observed that a conventional hinge (e.g., hinge 12 of prior art label 10 in FIGS. 1-1c) is intentionally not a part of the construction of novel label 20. Even though label 20 does not include a “built-in” hinge, it still functions in booklet fashion as will be described with reference now to FIG. 2a. In that illustration, label 20 has been affixed to container C in a process direction D from FIG. 2. In direction D, leading edge 14′ including release-reseal system 16′ is first affixed to container C. It will therefore be appreciated upon examination of the drawing that opposing leading edge 14 of label 20, in turn affixed to container C, covers edge 14′. Thereby, a hinge is effectively created as is evident when label 20 is (i) opened at release-reseal system 16 and (ii) the top ply is unwrapped by a user in direction D about container C to a vicinity where initial leading edge 14′ had first been affixed. It will be appreciated that, although not illustrated, an application of novel label 20 in process direction D′ would have a similar result, with edge 14 and release-reseal system 16 being covered and release-reseal system 16′ being manipulable by the user when the label is opened in direction D′.

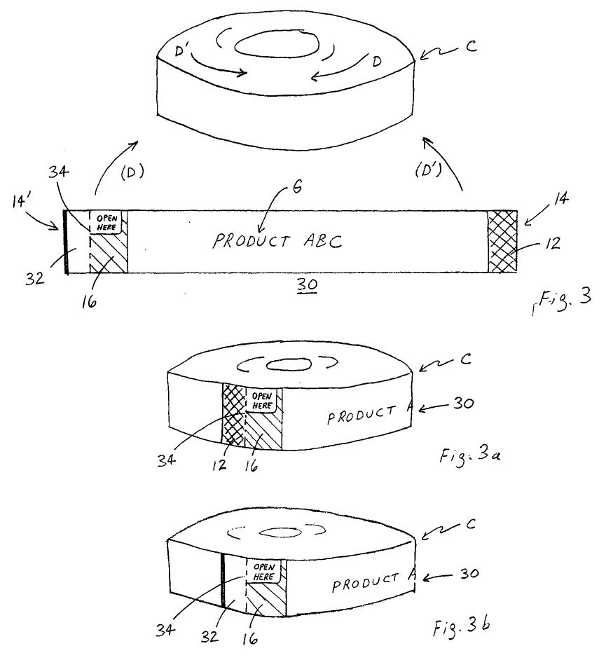

In FIG. 3, an alternative embodiment of the expanded content label for bi-directional application of the present invention 30 is illustrated as being affixed to a container in a process that is moving in a selected direction D or D′. In this alternative, exemplary embodiment, label 30 includes top and bottom material plies (and may include additional interior plies) along with any desired graphics G. Like exemplary label 20, label 30 includes opposite leading edges 14 and 14′. Label 30 however, unlike label 20, makes use of a hinge 12 at edge 14 along with, at opposite edge 14′, a (i) set-back portion 32 with adjacent release-reseal system 16 and (ii) cut 34 (through the top ply, whether completely or partially; but intentionally excluding cutting the bottom ply), in a heretofore unknown construction. Set-back portion 32 is, preferably, simply a portion of the top and bottom plies, and cut 34 enables the top ply to be separated from the bottom ply by a user as will be described. Those of ordinary skill in the label arts will, however, recognize that set-back portion 32 could comprise any number of plies as may be desired in a particular construction in accordance with the present invention, irrespective of the actual number of plies in the particular label. It will be seen that this novel configuration of label 30 also overcomes, like label 20, the aforedescribed problems associated with un-compatible application process directions. With reference to FIG. 3a, label 30 has been affixed to container C in a process direction D from FIG. 3. In direction D, leading edge 14′, including set-back portion 32, cut 34, and release-reseal system 16, is initially affixed to container C by any suitable means as aforementioned relative to label 20, with label 30 thereupon being wrapped circumferentially around container C. By way of chosen adhesive, opposing leading edge 14 including hinge 12 is then affixed to container C by covering set-back portion 32 to a point that is, preferably, immediately adjacent to, but not covering, cut 34. The only requirement in this regard is that edge 14 does not cover cut 34. It will therefore be appreciated, upon examination of FIG. 3a, that when label 30 is opened at release-reseal system 16, the top ply may then be unwrapped by a user in direction D′ about container C to a point where hinge 12 is affixed to container C. It will be appreciated that, with reference to FIG. 3b, an application of alternative label 30 in process direction D′ would have a similar result, with edge 14 and hinge 12 being first affixed to container C and then covered over by set-back portion 32 and release-reseal system 16 at edge 14′. Release-reseal system 16 would then be manipulable by the user, and the top ply of label 30 could be opened at cut 34 in direction D′ (with set-back portion 32 remaining fixed) to a point where hinge 12 (not visible in the drawing) is affixed to container C (approximately co-located on container C with fixed set-back portion 32).

It is also to be understood, in a desired construction of label 30, that set-back portion 32 could advantageously serve as a removable element. Such a removable element could serve as, for example, a coupon, a game piece, a premium, a proof-of-purchase device, or any other “value-added” item. The removable element, in other words, could consist of a portion of the top ply which defines set-back portion 32 (as may be discerned from FIGS. 3 and 3b) and could carry any desired graphics to identify it as such (e.g., “remove me”).

It is to be particularly appreciated and emphasized that exemplary labels 20 and 30 of the present invention could be, as desired, affixed to containers in either direction D or D′ and in any suitable application method or environment such as in, for example, the aforementioned roll fed, pressure-sensitive, cut and stack, hot melt, and glue-applied techniques.

Also, regardless of a given embodiment of labels 20 and 30 discussed above, it is to be particularly appreciated that selected adhesives provided in any construction would preferably be set back to some degree from edges of the label plies, to inhibit any occurrence of “adhesive ooze” that may be experienced when the adhesives are tacky, pressure-sensitive, viscous liquid adhesives. In this regard also, it is to be appreciated that if a pressure-sensitive adhesive is utilized in a given construction of label 20 or 30, rather than a so-called “dry-curing” adhesive, then there will be a higher likelihood of the occurrence of “adhesive ooze” and many problems attendant therewith. For example, in a cut-and-stack operation, adhesive ooze can turn an entire stack of labels into an inoperative, congealed mass. This is known in the art as “blocking” in dispensing, application, and use of such labels.

Also, although described in terms of a cut and stack ECL, features of the expanded content label for bi-directional application of the present invention as alternatively exemplified in FIGS. 2 and 3 could, of course, be utilized with virtually any wrap-around booklet-type label.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto. It is to be appreciated that any of the components of exemplary labels 20 and 30 may be selectively provided in any suitable combination, for a particular desired use thereof. It is also to be understood in general that any suitable alternatives may be employed to provide the expanded content label for bi-directional application of the present invention. Lastly, the choice, of course, of compositions, sizes, and strengths of various aforementioned components of labels 20 and 30 are all a matter of design choice depending upon intended uses of the present invention.

Accordingly, these and other various changes or modifications in form and detail of the present invention may also be made therein, again without departing from the true spirit and scope of the invention as defined by the appended claims.

We claim:

1. An expanded content label for bi-directional application, comprising:
at least one top ply having a front surface and a back surface;
at least one bottom ply having a front surface and a back surface;
selected graphics provided on said at least one top ply and said at least one bottom ply;
a first leading edge and a second leading edge; and
a first release-reseal system and a second release-reseal system, each being associated with, respectively, said first leading edge and said second leading edge.

2. The expanded content label for bi-directional application of claim 1, further comprising (i) a pressure-sensitive adhesive on said back side of said at least one bottom ply, and (ii) a silicone liner, with said pressure-sensitive adhesive on said at least one bottom ply being in contact with and carried upon said silicone liner.

3. The expanded content label for bi-directional application of claim 1, for use in an application technique selected from the group consisting of roll fed, pressure-sensitive, cut and stack, hot melt, and glue-applied techniques.

4. An expanded content label for bi-directional application, comprising:
at least one top ply having a front surface and a back surface;
at least one bottom ply having a front surface and a back surface;
selected graphics provided on said at least one top ply and said at least one bottom ply; and
a first leading edge and an opposite leading edge, said first leading edge including a hinge portion and said opposite leading edge including (i) a cut through said at least one top ply, (ii) a set-back portion defined by said cut and said opposite leading edge, and (iii) a release-reseal system adjacent to said cut and said set-back portion.

5. The expanded content label for bi-directional application of claim 4, further comprising (i) a pressure-sensitive adhesive on said back side of said at least one bottom ply, and (ii) a silicone liner, with said pressure-sensitive adhesive on said at least one bottom ply being in contact with and carried upon said silicone liner.

6. The expanded content label for bi-directional application of claim 4, for use in an application technique selected from the group consisting of roll fed, pressure-sensitive, cut and stack, hot melt, and glue-applied techniques.

7. The expanded content label for bi-directional application of claim 4, further comprising a removable element, said removable element consisting of a portion of said at least one top ply which defines said set-back portion.
